(19) United States
(12) Patent Application Publication
(10) Pub. No.: US 2020/0406833 A1
(43) Pub. Date: Dec. 31, 2020

(54) NAVIGATION AND MONITORING SYSTEM FOR VEHICLES

(71) Applicant: Hugh Lafon Carter, Burlington, NJ (US)

(72) Inventor: Hugh Lafon Carter, Burlington, NJ (US)

(21) Appl. No.: 16/885,349

(22) Filed: May 28, 2020

Related U.S. Application Data
(60) Provisional application No. 62/866,936, filed on Jun. 26, 2019.

(51) Int. Cl. B60R 11/04; G01S 7/02; G01S 7/48; H04N 5/225

(52) U.S. Cl. CPC B60R 11/04; H04N 5/2252; G01S 7/4806; G01S 7/022

(57) ABSTRACT

A system for monitoring a vehicle may contain at least one image capturing device and contain a navigational system. The device may further have functionality to send data collected by the device to a server for recordation, preservation, and review.

### CLAIM OF PRIORITY

The present application is a U.S. Non-Provisional Application claiming priority to U.S. Provisional Application No. 62/866,936 filed Jun. 26, 2019 entitled “NAVIGATION AND MONITORING SYSTEM FOR VEHICLES”, the disclosure of which is incorporated herein by reference in its entirety.”

### FIELD OF THE EMBODIMENTS

The field of the invention and its embodiments relate to systems for monitoring a vehicle and for navigating said vehicle. In particular, the embodiments relate to a device that enables enhanced vehicle monitoring and interactivity as well as serving as an uplink to communicate information associated with said device to a server.

### BACKGROUND OF THE EMBODIMENTS

Video recorders or dash mounted cameras, either stock or aftermarket, are installed on vehicles. These devices can record images of the passengers, the environment of the vehicle, and/or other views relating to the vehicle and its occupants. These same vehicles are often equipped with GPS navigation systems that allow the locations of the vehicles to be tracked. In the event of an accident, law enforcement event, or other incident involving the vehicle or the actions of its occupants, however, there is currently no means for independently correlating the occurrence of events within or outside the vehicle with the specific location of the vehicle at the time of the events.

### Review of Related Technology

U.S. Pat. No. 7,728,721 pertains to an accessory system suitable for use in an interior cabin of a vehicle includes an attachment element adhesively attached to an interior surface of a windshield of a vehicle, and an accessory module. The accessory module includes structure adapted to attach to the attachment element. The accessory module encompasses an antenna and a forward-facing camera. The forward-facing camera has a forward field of view through the windshield of the vehicle and in the direction of forward travel of the vehicle. The accessory system may include an image processor for processing image data captured by the forward-facing camera. The forward-facing camera may capture images for at least one of a collision avoidance system and an automatic headlamp control system.

U.S. Patent Application 2008/0309762 pertains to a mobile digital video surveillance recorder with GPS mapping capability is provided that is carried by a vehicle and equipped with a plurality of channel inputs. An associated monitor can be carried by the vehicle to allow the driver to view the camera images being recorded real-time, or the monitor can be located remotely for playback and review of the recorded images later. The monitor displays a split screen that can display one or more images as taken from different cameras. Video feed from an associated GPS navigation system is piped into one of the video channel inputs such that GPS location with mapping is visually displayed as one of the remaining split-screen images on the monitor. The displayed data therefore presents concurrent images of camera video and GPS video feed so that the specific location of the vehicle at the time a camera image was recorded is presented.

U.S. Patent Application 2004/0145457 pertains to a vehicular video mirror system includes an interior rearview mirror assembly and a video display assembly. The interior rearview mirror assembly includes a mirror casing incorporating a reflective element. The reflective element has a rearward field of view when the interior rearview mirror assembly is mounted in a vehicle. The mirror assembly further includes a mirror-mounting portion, which is adapted to mount the interior rearview mirror assembly at an interior portion of the vehicle, such as a windshield portion or a header portion. The mirror casing is adjustable about the mirror-mounting portion for adjusting the rearward field of view of the reflective element. The video display assembly includes a video screen which is incorporated in a video display housing. The video display assembly also includes a display-mounting portion, which is adapted to mount the video display assembly at the interior portion of the vehicle. The display housing is adapted to be adjustable about the display-mounting portion for adjusting the orientation of the video screen and, further, for moving the display housing to a stowed position whereby the video screen is generally not viewable by a driver when seated in a vehicle seat in the vehicle to thereby minimize the distraction to the driver of the vehicle.

Various devices are known in the art. However, their structure and means of operation are substantially different from the present disclosure. The other inventions also fail to solve all the problems taught by the present disclosure. At least one embodiment of this invention is presented in the drawings below and will be described in more detail herein.

### SUMMARY OF THE EMBODIMENTS

In general, the present invention and its embodiments provide for an image capturing device having built in navigational functionality. In some embodiments, a radar detector is further encompassed. The image capturing capability is configured to provide 360-degree views of an environment of the location of the device. In at least one embodiment, the device contains a transceiver configured to transmit and receive data from a server coupled to the device.

The embodiments of the present invention allow for continuous monitoring of the environment of the vehicle before, during, and after use by the occupant(s). This effectively allows the device to function as a driving aid as well as a theft prevention device. Further, the side facing cameras allow for interactions with law enforcement to be adequately recorded and simultaneously uploaded to a remote server for preservation. In some embodiments, live streaming of the images captured by the cameras is permitted thereby allowing the vehicle and its occupants to be viewed in real time.

In one embodiment of the present invention there is a device for monitoring a vehicle environment, the device comprising a first image capturing device, a second image capturing device, a third image capturing device, and a fourth image capturing device, wherein an orientation of each of the first image capturing device, the second image capturing device, the third image capturing device, and the fourth image capturing device are difference from one another; a processor and memory configured to store a representation captured by any of the first image capturing device, the second image capturing device, the third image capturing device, and the fourth image capturing device; a touch based display; a global positioning system sensor; at least one of: a laser light sensor and a radio frequency sensor; and a mounting apparatus.

In yet another embodiment of the present invention there is a device for monitoring a vehicle environment, the device comprising: a first camera, a second camera, a third camera, and a fourth camera, wherein an orientation of each of the first camera, the second camera, the third camera, and the fourth camera, are different from one another, and wherein an orientation of the first camera and the third camera an in opposing directions from one another, and wherein an orientation of the second camera and the fourth camera and in opposing directions from one another; a touch-based display configured to display a representation of a location of a vehicle; a sensor configured to receive light signals and/or radio frequency signals; and a processor and a memory configured to: record images captured by the first camera, the second camera, the third camera, and the fourth camera, and create alerts visible to the user via the touch-based display; a transceiver configured to send data collected by the device to a server.

In general, the present invention succeeds in conferring the following, and others not mentioned, benefits and objectives.

It is an object of the present invention to provide a device that monitors an internal and/or external environment of a vehicle.

It is an object of the present invention to provide a device that detects radar signals from a third party.

It is an object of the present invention to provide a device that contains a navigation function.

It is an object of the present invention to provide a device that allows for images and/or video to be live streamed.

It is an object of the present invention to provide a device that has touch screen capabilities.

It is an object of the present invention to provide a device can auto swivel to remain oriented in a fixed direction.

It is an object of the present invention to provide a device that allows for anti-theft vehicle monitoring.

It is an object of the present invention to provide a device that is easy to set up and use.

### BRIEF DESCRIPTION OF THE DRAWINGS

FIG. 1 is a first perspective view of an embodiment of the present invention.

FIG. 2 is a second perspective view of an embodiment of the present invention.

FIG. 3 is a first side view of an embodiment of the present invention.

FIG. 4 is a front view of an embodiment of the present invention.

FIG. 5 is a back view of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

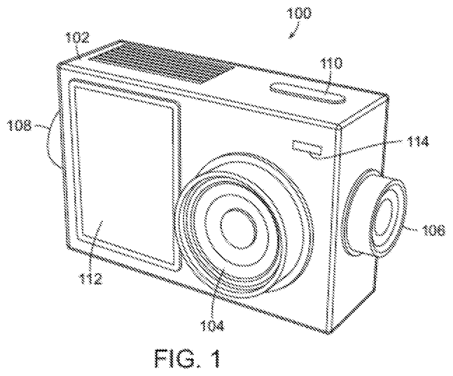

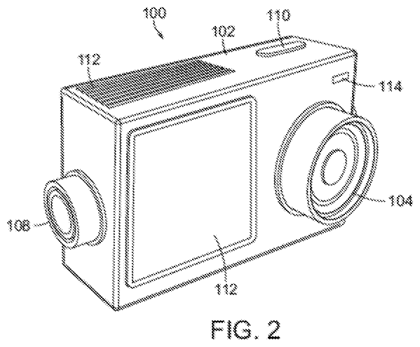

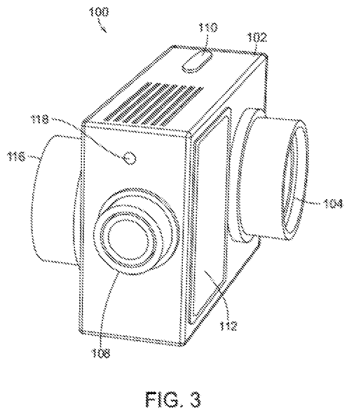

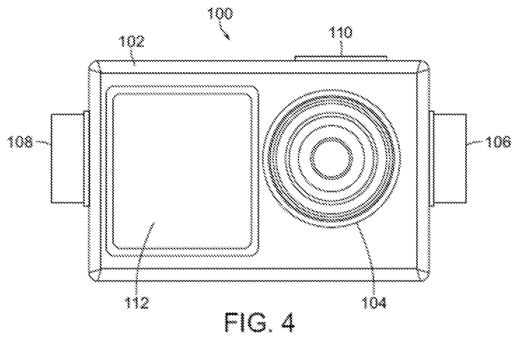

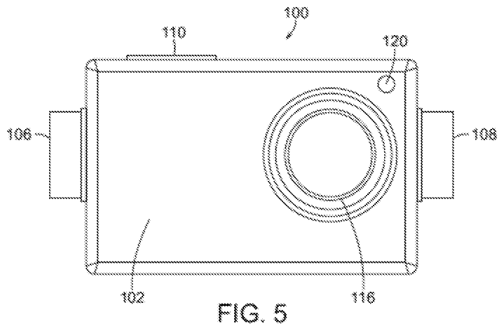

Referring now to FIGS. 1-5, there is an embodiment of the present invention. The device 100 may comprise a housing 102, a first camera 104, a second camera 106, a third camera 108, and a fourth camera 116. Further, the device 100 comprises a light/laser sensor 120, a touch-based display 112, a depressible button 110, status LED 118.

In some embodiments, a mounting apparatus may be used to secure a position of the device 100 within a vehicle. The mounting apparatus may couple the device 100 to a window of the vehicle. The mounting apparatus may removably couple the device 100 to the vehicle. Typical mechanisms such as suction mechanisms and adhesives may be used to create the pairing between the window and the mounting mechanism. The mounting mechanism further has a receptacle to receive the device 100. The receptacle may comprise arms or other devices to form a friction fit with the device 100. In other embodiments, the mounting device is adapted to engage grooves or other structures of the device 100 in order to secure a position of the device and the mounting mechanism.

In at least one embodiment, the mounting mechanism allows for free rotation of the device 100 when coupled to the mounting mechanism. This may allow for stabilization of the video or images captured by the device 100. Further, this may allow for a particular orientation of the device to be maintained by the device 100 when the vehicle is in motion. In yet other embodiments, the mounting mechanism may have a transceiver configured to receive a signal from an electronic device. This may allow for the mounting apparatus to control a position of the device 100 remotely.

Preferably, the device 100 has a housing 102 that comprises a first side, second side, third side, fourth side, fifth side, and sixth side. In other embodiments, other housing iterations (shapes, sizes, etc.) are envisioned. The device 100 has four cameras: a first camera 104, a second camera 106, a third camera 108, and a fourth camera 116. Each of the cameras are disposed on a separate side of the housing 102. It is preferable that each of the four cameras are oriented or face in a different direction. In at least one embodiment, the cameras are oriented such that each camera is oriented 90 degrees from another camera. Combined with the desired field of view for each of the cameras, this allows for 360 degree camera coverage by the device 100. In at least one embodiment, a first pair of cameras face in opposing directions and a second pair of cameras face in opposing directions. The direction of the first pair of cameras is distinct from the direction of the second pair of cameras.

The cameras may be configured to capture video in 1080p, 4 k, or other desirable resolution. The cameras may be configured to capture images having at least 5 megapixels. Each of the cameras may be capable of being independently controlled. For example, one camera can record video while another camera is simultaneously capturing a still image. In some embodiments, a motion sensor is coupled to the camera such that movement detection by the motion sensor causes activation of the camera coupled to the motion sensor.

The device 100 further has a touch-based display 112. Such a touch-based display may be a resistive touch display, a capacitive touch display, or other suitable display. The touch-based display 112 provides a visual output to the user of various data associated with and collected by the device. For example, the user may adjust various settings of the device 100 via the touch-based display 112. Further, the touch-based display may be configured to output a navigational program to guide a driver in reaching a desired destination. The device further incorporates global positioning system capabilities to aid in such functionality.

On a front of the device 100, there is a light/laser sensor 120 configured to receive various forms of light, radio frequency signals, laser light, etc. Typically, this is used to receive incoming transmission from radar guns utilized by law enforcement. Once detected, the device 100 may trigger an audible alarm via a speaker built into the device. In another embodiment, the device 100 may cause an alert to be generated on the touch-based display 112 warning the driver to slow down.

Another feature of the device 100 is that the video or images captured by the device 100 may be live streamed by the device 100. This may be done by interacting with the touch-based display 112 or there may be a dedicated button on the device to allow the streaming action to occur. The images and video may be streamed directly to a dedicated website or to a third-party mobile and/or web application. For example, there may be a dedicated touch sensitive button that allows for the images or video to be streamed directly to Facebook Live. This may be done solely for entertainment purposes or may be done in the event of a law enforcement event. For example, a user is pulled over by a police officer and wants to obtain and preserve or live stream the interaction for safety purposes. Further, such data may be useful in the event of any court proceeding.

At least one depressible button 110 is present on the device as well as at least one status LED 118. The depressible button 110 is used to interact with various features of the device 100, in particular, to turn on/off various functionality associated with the device 100. The status LED 118 may be used to signify the operation of a particular functionality (i.e. recording on/off) such that a user has a visual cue as to the operation of the intended functionality.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A device for monitoring a vehicle environment, the device comprising:
a first image capturing device, a second image capturing device, a third image capturing device, and a fourth image capturing device,
wherein an orientation of each of the first image capturing device, the second image capturing device, the third image capturing device, and the fourth image capturing device are different from one another;
a processor and memory configured to store a representation captured by any of the first image capturing device, the second image capturing device, the third image capturing device, and the fourth image capturing device;
a touch-based display;
a global positioning system sensor;
at least one of: a laser light sensor and a radio frequency sensor; and
a mounting apparatus.

2. The device of claim 1 wherein an orientation of the first camera and the third camera an in opposing directions from one another.

3. The device of claim 1 wherein an orientation of the second camera and the fourth camera and in opposing directions from one another.

4. The device of claim 1 wherein the mounting apparatus is configured to couple the device to a dashboard of a vehicle or a window of the vehicle.

5. The device of claim 1 wherein the mounting apparatus allows for rotational movement of the device.

6. A device for monitoring a vehicle environment, the device comprising:
a first camera, a second camera, a third camera, and a fourth camera,
wherein an orientation of each of the first camera, the second camera, the third camera, and the fourth camera, are different from one another, and
wherein an orientation of the first camera and the third camera an in opposing directions from one another, and
wherein an orientation of the second camera and the fourth camera and in opposing directions from one another;
a touch-based display configured to display a representation of a location of a vehicle;
a sensor configured to receive light signals and/or radio frequency signals; and
a processor and a memory configured to:
record images captured by the first camera, the second camera, the third camera, and the fourth camera, and
create alerts visible to the user via the touch-based display;
a transceiver configured to send data collected by the device to a server.

7. The device of claim 6 wherein at least one of the first camera, the second camera, the third camera, and the fourth camera are controlled by a timer.

8. The device of claim 6 wherein the images captured by the first camera, the second camera, the third camera, and the fourth camera are still images or videos.

9. The device of claim 6 wherein the images captured by the first camera, the second camera, the third camera, and the fourth camera are configured to be live streamed to a third-party web and/or mobile application.
